(19) United States
(12) Patent Application Publication
(10) Pub. No.: US 2018/0259910 A1
(43) Pub. Date: Sep. 13, 2018

(54) PORTABLE APPARATUS COMPONENT FIXATION STRUCTURE

(71) Applicant: Seiko Instruments Inc., Chiba-shi (JP)

(72) Inventors: Katsunobu IGUCHI, Chiba-shi (JP); Ryo HATTORI, Chiba-shi (JP); Yasunori HARA, Chiba-shi (JP)

(21) Appl. No.: 15/914,706

(22) Filed: Mar. 7, 2018

(30) Foreign Application Priority Data
Mar. 13, 2017 (JP) 2017-047481

(51) Int. Cl. G04D 1/00; G04D 1/10

(52) U.S. Cl. CPC G04D 1/0042; G04D 1/10

(57) ABSTRACT

A portable apparatus component fixation structure which helps to secure the positioning accuracy for a second member (a mounted member) and which makes it possible to easily mount the second member is to be provided. A fixation structure is equipped with a fixation portion provided on a main plate and a regulating portion formed on a display plate. The fixation portion has a first pin and a second pin. The second pin has an inclined surface. The inclined surface is a surface generating a pressing force toward the regulating portion as the display plate approaches the main plate. Locking is effected in a state in which the regulating portion is held between the first pin and the second pin.

### RELATED APPLICATIONS

This application claims priority under 35 U.S.C. § 119 to Japanese Patent Application No. 2017-047481 filed on Mar. 13, 2017, the entire content of which is hereby incorporated by reference.

### BACKGROUND OF THE INVENTION

### 1. Field of the Invention

The present invention relates to a portable apparatus component fixation structure.

### 2. Description of the Related Art

As a timepiece display plate fixation structure, there has been known one in which a cutout is formed in an outer peripheral portion of a timepiece display plate and in which a pair of columnar protrusions are mounted to an auxiliary ring (hereinafter referred to as a main plate), with the timepiece display plate being mounted to the main plate through engagement of the cutout with the pair of columnar protrusions.

More specifically, the cutout is matched with the pair of columnar protrusions, and, in this state, the timepiece display plate is pressed against the main plate. Due to a wall portion of the cutout, the pair of columnar protrusions undergo elastic deformation so as to move toward each other, and the cutout is pushed into the pair of columnar protrusions. As a result, the cutout is engaged with the pair of columnar protrusions, and the timepiece display plate is mounted to the main plate (See, for example, Patent Document 1 (JP-A-2001-194470)).

The cutout is pushed into the pair of columnar protrusions, whereby it is possible to set the timepiece display plate accurately in position.

It is desirable for the protruding dimension of the columnar protrusions to be suppressed to a minimum taking the thickness dimension of the timepiece as a whole into consideration. Due to the suppression of the protruding dimension of the columnar protrusions, however, the elastic deformation amount of the columnar protrusions is diminished. Thus, there room for an improvement in terms of workability when the timepiece display plate (that is, a second member) is mounted to the main plate (that is, a first member).

On the other hand, it might be possible to secure the elastic deformation amount by increasing the protruding dimension of the columnar protrusions. If, however, the protruding dimension of the columnar protrusions were increased, the thickness of the timepiece as a whole would be increased, thereby impairing the outward appearance of the timepiece.

### SUMMARY OF THE INVENTION

The present invention has been made in view of these circumstances. It is an object of the present invention to provide a portable apparatus component fixation structure which helps to secure the positioning accuracy for a second member (that is, a mounted member) and which makes it possible to easily mount the second member.

To achieve the above object, there is provided, in accordance with an embodiment of the present invention, a portable apparatus component fixation structure including: a fixation portion provided on a first member, having a first holding portion and a second holding portion, and having an inclined surface on one of the first holding portion and the second holding portion; and a regulating portion which is provided on a second member and which, while held between the first holding portion and the second holding portion, receives a pressing force from the inclined surface as it approaches the first member to be thereby locked to the fixation portion.

In this construction, the fixation portion has the first holding portion and the second holding portion, and the inclined surface is formed on the second holding portion. By pressing the regulating portion against the inclined surface, it is possible to generate a pressing force from the inclined surface toward the regulating portion. Thus, it is possible to press the regulating portion against the first holding portion. As a result, it is possible to fix the regulating portion in position in a state in which it is firmly held between the first holding portion and the second holding portion.

Here, by pressing the regulating portion against the first holding portion, it is possible to set the regulating portion accurately in position by the first holding portion, making it possible to secure the positioning accuracy for the second member.

Further, solely by pressing the regulating portion against the inclined surface, it is possible to fix the regulating portion in position in a state in which it is firmly held between the first holding portion and the second holding portion. As a result, the second member can be easily mounted to the first member.

In the above-described mode, the first holding portion may be a first pin formed as a column, and the second holding portion may be a second pin formed as a truncated cone and having the above-mentioned inclined surface.

In this construction, the first holding portion and the second holding portion, that is, the fixation portion, can be formed in a simple structure.

In the above-described mode, the second pin may be gradually reduced in diameter from the first member toward the second member.

In this construction, by bringing the second member close to the first member, it is possible to press the regulating portion against the inclined surface of the second pin. As a result, it is possible to generate a pressing force from the inclined surface toward the regulating portion, making it possible to press the regulating portion against the first pin. Thus, the regulating portion can be easily fixed in position in a state in which it is firmly held between the first pin and the second pin.

In the above-described mode, the second pin may be gradually increased in diameter from the first member toward the second member.

In this construction, by mounting the second pin to the first member from the second member side, it is possible to press the inclined surface of the second pin against the regulating portion. That is, it is possible to generate a pressing force from the inclined surface toward the regulating portion, making it possible to press the regulating portion against the first pin. As a result, it is possible to fix the regulating portion in position in a state in which it is firmly held between the first pin and the second pin.

Further, the second pin is gradually increased in diameter from the first member toward the second member, whereby it is possible to suppress in a more satisfactory manner detachment of the regulating portion from the fixation portion by the second pin.

In the above-described mode, the second pin may be rotatably mounted to the first member, and a center axis of a proximal end portion on the first member side and a center axis of a distal end portion on the side opposite the first member may be offset from each other.

In this construction, the second pin is rotatably mounted to the first member, and the center axis of the proximal end portion and the center axis of the distal end portion are offset from each other. Thus, it is possible to vary an inclination angle in the peripheral direction of the second pin. That is, by rotating the second pin, it is possible to select the inclined surface of the second pin in conformity with the regulating portion. As a result, fine adjustment of the interference by the inclined surface is possible when fixing the regulating portion (that is, the display plate) in position.

In the above-described mode, the second pin may be detachably mounted to the first member.

In this construction, the second pin is detachably mounted to the first member, whereby it is possible to replace the second pin in conformity with the regulating portion. That is, it is possible to prepare a large number of second pins of different configurations, and to select a second pin of an appropriate configuration in conformity with the regulating portion. As a result, fine adjustment of the interference due to the inclined surface is possible when fixing the regulating portion (that is, the display plate) in position.

In the above-described mode, the regulating portion may have an inclined side opposite the inclined surface and formed in an inclined configuration in conformity with the inclined surface.

In this construction, the surface of the regulating portion opposite the inclined surface is formed in an inclined configuration in conformity with the inclined surface. Thus, it is possible to increase the contact area in which the surface of the regulating portion is held in contact with the inclined surface. As a result, it is possible to retain the surface of the regulating portion on the inclined surface in a more satisfactory fashion, making it possible to mount the regulating portion more firmly to the fixation portion.

In the above mode, the first member may be a main plate of a timepiece provided with the fixation portion, and the second member may be a display plate of a timepiece provided with the regulating portion.

In this construction, it is possible to mount the display plate of the timepiece to the main plate in a state in which the positioning accuracy is secured. Further, it is possible to mount the display plate easily to the main plate.

According to a mode of this invention, it is possible to secure the positioning accuracy for the second member (mounted member), and to easily mount the second member.

### BRIEF DESCRIPTION OF THE DRAWINGS

FIG. 1 is an exploded perspective view of a timepiece according to a first embodiment of the present invention.

FIG. 2 is a plan view of a fixation structure according to the first embodiment of the present invention.

FIG. 3 is a linearly developed side view of the fixation structure according to the first embodiment of the present invention.

FIG. 4 is a plan view of a fixation structure according to a second embodiment of the present invention.

FIG. 5 is a side view of the fixation structure according to the second embodiment of the present invention.

FIG. 6 is a plan view of a fixation structure according to a third embodiment of the present invention.

FIG. 7 is a side view of the fixation structure according to the third embodiment of the present invention.

FIG. 8 is a sectional view of a second pin according to a modification of the third embodiment of the present invention.

FIG. 9 is a plan view of a fixation structure according to a fourth embodiment of the present invention.

FIG. 10 is a side view of a second pin according to the fourth embodiment of the present invention.

FIG. 11 is a sectional view of the second pin according to the fourth embodiment of the present invention.

### DETAILED DESCRIPTION OF THE EMBODIMENTS

In the following, embodiments of the present invention will be described with reference to the drawings. While in the embodiments described below the present invention is applied to a display plate 5 of a timepiece 10 as a portable apparatus component, this should not be construed restrictively. In other examples, the portable apparatus component may consist of a solar panel of a timepiece, a display panel of a portable terminal or the like.

Further, the fixation structure of the portable apparatus component will be simply referred to as the “fixation structure.”

### First Embodiment

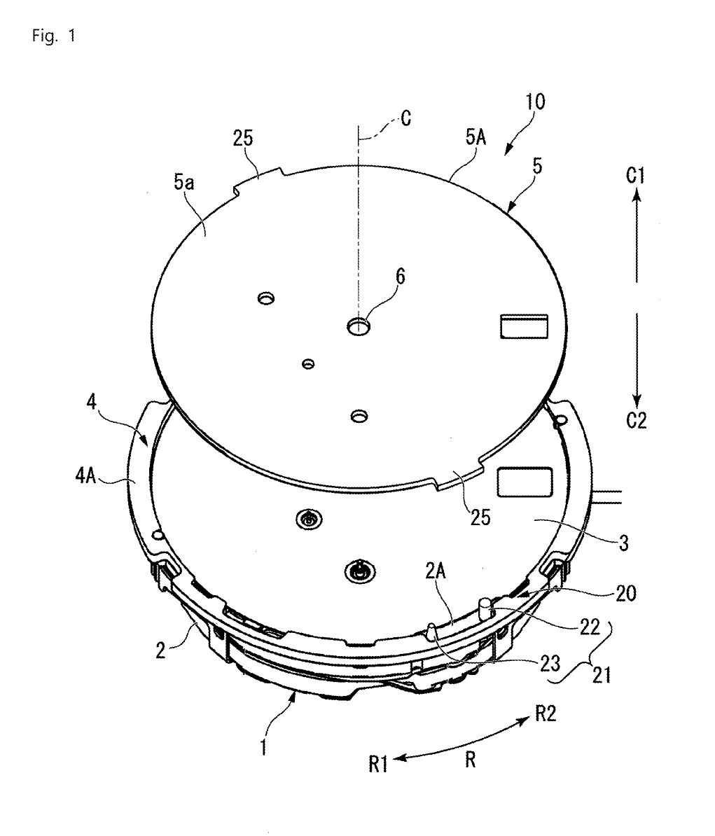

FIG. 1 is an exploded perspective view of a timepiece 10 according to the first embodiment.

As shown in FIG. 1, the timepiece 10 is equipped with a movement 1 and a display plate 5. The movement 1 is equipped with a main plate 2, a solar battery 3, a frame body 4, and an indicator hand shaft (not shown). The display plate 5 is a second member, and the main plate 2 is a first member.

Symbol C indicates a center axis of the timepiece 10. Of the directions along the center axis C, one direction is referred to as a first axial direction C1, and the direction opposite the first axial direction C1 is referred to as a second axial direction C2. The center axis C extends through the center of the movement 1 (the main plate 2, the solar battery 3, the frame body 4, and the indicator hand shaft), and the center of the display plate 5. The directions around the center axis C are referred to as peripheral directions R. Of the peripheral directions R, one direction is referred to as a first peripheral direction R1, and the direction opposite the first peripheral direction R1 is referred to as a second peripheral direction R2.

The display plate 5 is situated on the first axial direction C1 side.

The timepiece 10 has indicator hands (hour hand, minute hand, and second hand) (not shown) mounted to the indicator hand shaft. Although not shown, the timepiece 10 may be equipped with a windshield, a case back, a bezel, a case, and a belt.

The case accommodates the movement 1 and the display plate 5. The windshield is mounted to the opening of the case by means of the bezel. The windshield is formed of a material allowing transmission of light like sunlight such as glass or plastic.

The movement 1 is equipped, for example, with a circuit block (an oscillation circuit, a control circuit, etc.), a battery (secondary battery), and a motor. The battery is charged with electrical energy supplied by the solar battery 3. The motor drives the indicator hand shaft.

The main plate 2 has a plate-like main plate main body portion 2A and a pair of fixation portions 21 (one of the fixation portions 21 is omitted in the drawing). The main plate main body portion 2A is formed in a substantially circular annular configuration as seen from, for example, a direction parallel to the center axis C.

The pair of fixation portions 21 are arranged on the main plate main body portion 2A at equal intervals in the peripheral directions R.

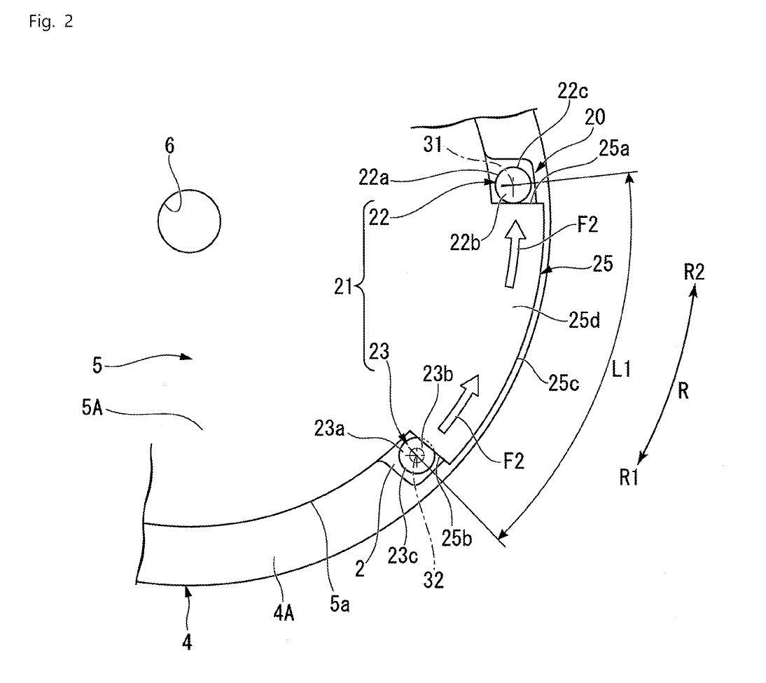

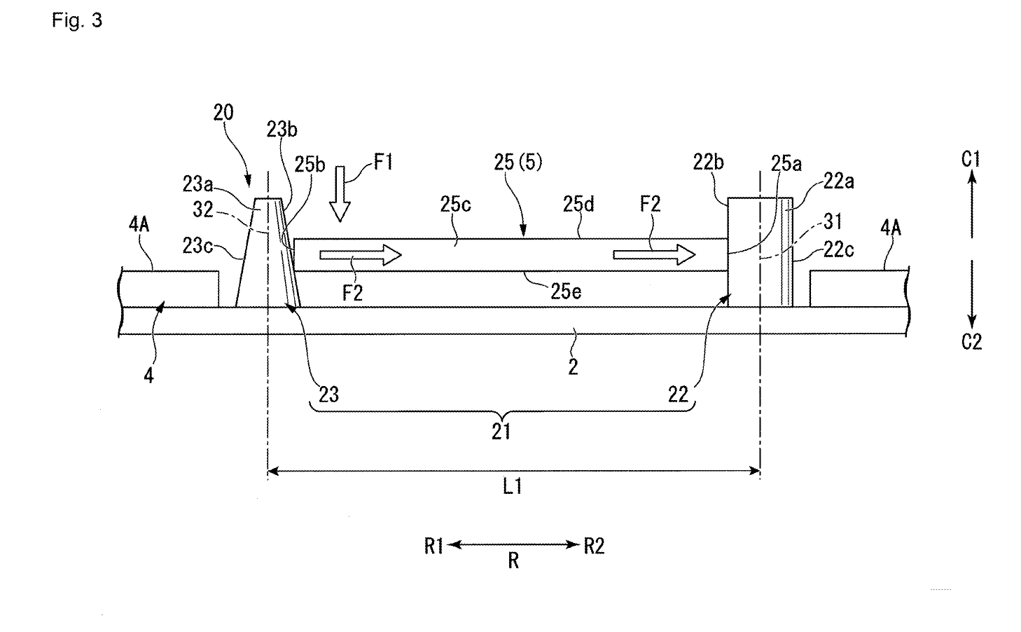

The number of the fixation portions 21 is not restricted to two. It may be one or an arbitrary number of two or more (a plurality of them). Each fixation portion 21 is equipped with a first pin 22 and a second pin 23. The first pin 22 and the second pin 23 are a first holding portion and a second holding portion holding a regulating portion 25 therebetween. The fixation portions 21 will be described in detail with reference to FIGS. 2 and 3.

The solar battery 3 operates as a power generating portion converting light from the sun, illumination or the like to electrical energy. The solar battery 3 is a plate member formed in a plate-like configuration. The solar battery 3 is arranged at a position where it overlaps the first axial direction C1 side of the main plate 2.

The frame body 4 has a frame body main body portion 4A and a plurality of frame body fixation portions (not shown). The frame body main body portion 4A is formed in a substantially circular annular configuration as seen from, for example, a direction parallel to the center axis C. The frame body main body portion 4A is locked to the main plate 2 by locking the frame body fixation portions to the main plate 2. The frame body main body portion 4A abuts a part of the solar battery 3, i.e., the surface thereof on the first axial direction C1 side.

Further, the frame body main body portion 4A is formed in a configuration surrounding the outer periphery of the display plate 5.

The display plate 5 is, for example, a dial. The display plate 5 is arranged within the frame body 4 and at a position where it overlaps the first axial direction C1 side of the solar battery 3. The display plate 5 may abut the solar battery 3 or may be spaced away from the solar battery 3.

The display plate 5 has a display main body portion 5A and a pair of regulating portions 25. The display plate 5 is formed so as to allow transmission of light necessary for recharging the solar battery 3. For example, the display plate 5 is formed of a material allowing transmission of light. It is only necessary for the display plate 5 to allow transmission of light necessary for recharging. Even when a material not allowing transmission of light is employed, there may be formed, for example, a plurality of minute through-holes, through which transmission of light is allowed.

The display main body portion 5A is formed in a substantially circular configuration as seen from a direction parallel to the center axis C. At the center of the display main body portion 5A, there is formed a through-hole 6 through which an indicator hand shaft is passed. A first main surface 5a of the display main body portion 5A has a display region formed over the entire periphery around the center axis C and displaying time. A plurality of graduations (indicators) indicating time are formed in this display region. The plurality of graduations are formed, for example, at predetermined positions around the center axis C, and time is indicated by indicator hands.

The pair of regulating portions 25 are arranged on the first main surface 5a of the display main body portion 5A at equal intervals in the peripheral directions R. The number of the regulating portions 25 is not restricted to two. It may be one or an arbitrary number of two or more (a plurality of them). The regulating portions 25 will be described in detail with reference to FIGS. 2 and 3.

A fixation structure 20 is formed by the pair of fixation portions 21 and the pair of regulating portions 25. Here, the pair of fixation portions 21 are of the same configuration. In the following, one of the pair of fixation portions 21 will be described, and a description of the other fixation portion 21 will be left out. Further, the pair of regulating portions 25 are of the same configuration. In the following, one of the pair of regulating portions 25 will be described, and a description of the other regulating portion 25 will be left out.

FIG. 2 is a plan view of the fixation structure 20 according to the first embodiment. FIG. 3 is a side view of the fixation structure 20 according to the first embodiment. In FIG. 3, to facilitate the understanding of the construction of the fixation structure 20, the fixation structure 20 is shown in a state in which it is developed linearly.

As shown in FIGS. 2 and 3, the fixation structure 20 is formed by the fixation portion 21 and the regulating portion 25. The first pin 22 and the second pin 23 of the fixation portion 21 are arranged at a predetermined interval L1 in the peripheral directions R.

The first pin 22 is arranged on the second peripheral direction R2 side of the peripheral directions R. The first pin 22 is formed in a columnar configuration and protrudes from the main plate 2 in the first axial direction C1 such that an axis 31 thereof is orthogonal to the main plate 2. That is, the first pin 22 is a straight pin an outer peripheral surface 22a of which extends from the main plate 2 in the first axial direction C1 so as to be orthogonal to the main plate 2.

The second pin 23 is arranged on the first peripheral direction R1 side of the peripheral directions R. The second pin 23 is formed as a truncated cone, and protrudes from the main plate 2 in the first axial direction C1 such that an axis 32 thereof is orthogonal to the main plate 2. The second pin 23 is a tapered pin having an inclined surface 23a gradually reduced in diameter from the main plate 2 in the first axial direction C1. The inclined surface 23a constitutes the outer peripheral surface of the second pin 23. The inclined surface 23a is inclined so as to gradually approach the axis 32 as it extends from the main plate 2 in the first axial direction C1.

While in the present embodiment the inclined surface 23a is formed on the second pin 23, this should not be construed restrictively. It is also possible for the first pin 22 to be provided with an inclined surface.

The regulating portion 25 is arranged between the first pin 22 and the second pin 23.

The regulating portion 25 protrudes radially outwards from the first main surface 5a of the display main body portion 5A. The regulating portion 25a has a first side 25a, a second side 25b, and an outer peripheral edge 25c.

The first side 25a is arranged on the first pin 22 side, and is formed linearly so as to extend radially outwards from the first main surface 5a of the display main body portion 5A. The first side 25a is formed linearly along the axis 31 of the first pin 22 so as to extend from a surface 25d on the first axial direction C1 side to a surface 25e on the second axial direction C2 side.

The second side 25b is arranged on the second pin 23 side, and is formed linearly so as to extend radially outwards from the first main surface 5a of the display main body portion 5A. Like the first side 25a, the second side 25b is formed linearly along the axis 32 of the second pin so as to extend from the surface 25d on the first axial direction C1 side to the surface 25e on the second axial direction C2 side.

The outer peripheral edge 25c is formed in an arcuate configuration from the distal end of the first side 25a to the distal end of the second side 25b.

Next, an example of how the display plate 5 is mounted to the main plate 2 by the fixation structure 20 will be described.

First, the regulating portion 25 is arranged between the first pin 22 and the second pin 23. The second side 25b of the regulating portion 25 comes into contact with a first pin 22 side surface 23b of the inclined surface 23a of the second pin 23. The first side 25a of the regulating portion 25 comes into contact with a second pin 23 side surface 22b of the outer peripheral surface 22a of the first pin 22.

In this state, the second side 25b side of the regulating portion 25 is pressed with a load F1 so as to bring it close to the main plate 2. The second side 25b of the regulating portion 25 is pressed against the inclined surface 23a of the second pin 23, and it is possible to generate a pressing force F2 from the inclined surface 23a toward the regulating portion 25. That is, the regulating portion 25 receives the pressing force F2 from the inclined surface 23a.

Thus, it is possible to press the regulating portion 25 against the inclined surface 23a of the second pin 23 and against the outer peripheral surface 22a of the first pin 22. As a result, it is possible to fix (lock) the regulating portion 25 in a state in which it is firmly held between the first pin 22 and the second pin 23.

Here, by pressing the first side 25a of the regulating portion 25 against the outer peripheral surface 22a of the first pin 22, it is possible to set the regulating portion 25 accurately in position by the first pin 22, making it possible to secure the positioning accuracy for the display plate 5.

Further, solely by pressing the second side 25b of the regulating portion 25 against the inclined surface 23a of the second pin 23, it is possible to fix the regulating portion 25 in a state in which it is firmly held between the first pin 22 and the second pin 23. As a result, the regulating portion 25 can be mounted to the fixation portion 21, and the display plate 5 can be easily mounted to the main plate 2.

Further, the first holding portion can be formed by the first pin 22 of a simple columnar configuration. Further, the second holding portion can be formed by the second pin 23 of a simple, truncated-cone-like configuration. As a result, the fixation portion 21 can be formed in a simple construction.

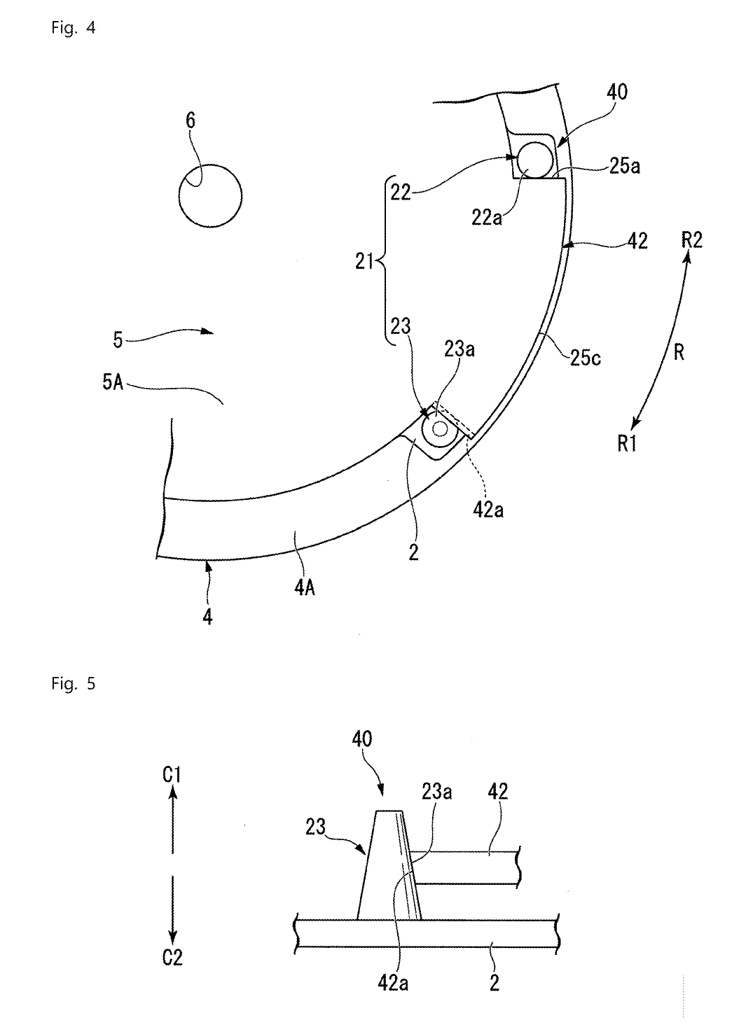

Next, fixation structures 40, 50, and 60 according to the second through fourth embodiments will be described with reference to FIGS. 4 through 11. Regarding the fixation structures 40, 50, and 60 of the second through fourth embodiments, the members that are the same as or similar to those of the fixation structure 20 of the first embodiment are indicated by the same reference numerals, and a detailed description thereof will be left out.

### Second Embodiment

FIG. 4 is a plan view of the fixation structure 40 according to the second embodiment. FIG. 5 is a side view of the fixation structure 40 according to the second embodiment.

As shown in FIGS. 4 and 5, in the fixation structure 40, the regulating portion 25 of the first embodiment is replaced by a regulating portion 42. Otherwise, it is of the same construction as the fixation structure 20 of the first embodiment.

In the regulating portion 42, the second side 25b of the regulating portion 25 of the first embodiment is replaced by a second side 42a. Otherwise, it is of the same construction as the regulating portion 25 of the first embodiment.

The second side 42a of the regulating portion 42 is an inclined side opposite the inclined surface 23a of the second pin 23. The second side 42a of the regulating portion 42 is formed in an inclined configuration along the inclined surface 23a of the second pin 23. Thus, the entire second side 42a comes into contact with the inclined surface 23a. That is, it is possible to secure a large contact area in which the second side 42a comes into contact with the inclined surface 23a. As a result, it is possible to retain the second side 42a of the regulating portion 42 by the inclined surface 23a of the second pin 23 in a more satisfactory manner, making it possible to mount the regulating portion 42 to the fixation portion 21 more firmly.

### Third Embodiment

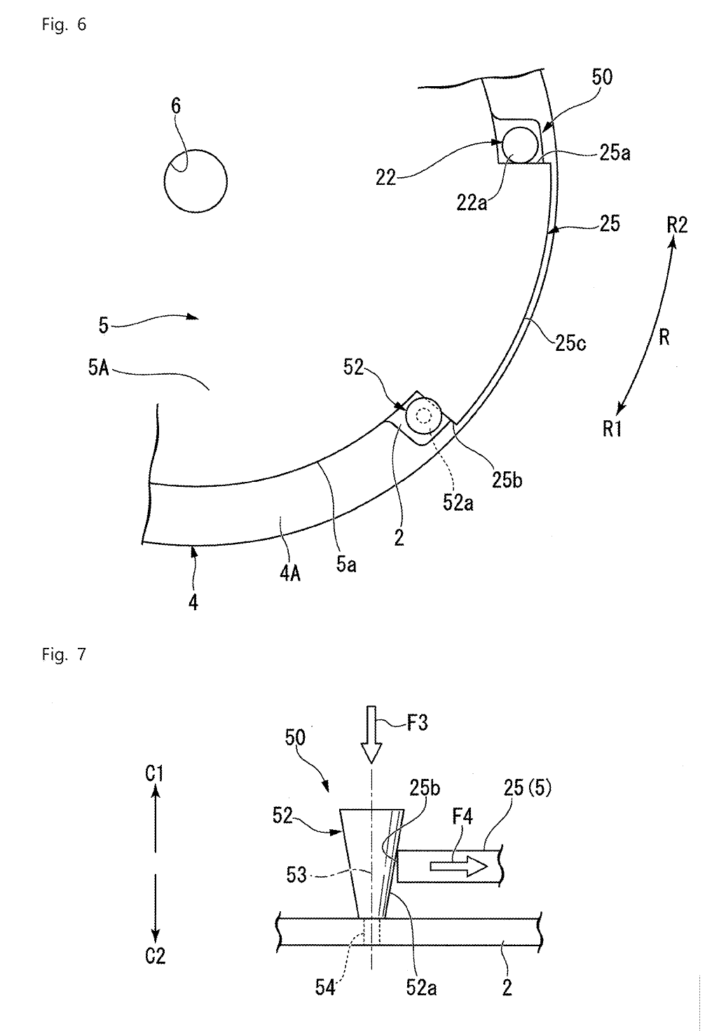

FIG. 6 is a plan view of the fixation structure 50 according to the third embodiment. FIG. 7 is a side view of the fixation structure 50 according to the third embodiment.

As shown in FIGS. 6 and 7, in the fixation structure 50, the second pin 23 of the first embodiment is replaced by a second pin 52. Otherwise, it is of the same construction as the fixation structure 20 of the first embodiment.

The second pin 52 is formed so as to be gradually increased in diameter from the main plate 2 toward the display plate 5 (in the first axial direction C1). That is, an inclined surface 52a of the second pin 52 is formed so as to be gradually spaced away from an axis 53 as it extends in the first axial direction C1 from the main plate 2. The inclined surface 52a forms the outer peripheral surface of the second pin 52.

The second pin 52 is mounted to the main plate 2 from the display plate 5 side as indicated by an arrow F3. Examples of the means for mounting the second pin 52 to the main plate 2 include the forcing of the pin into the main plate 2. More specifically, the second pin 52 has an insertion pin portion 54 protruding from the proximal end portion toward the main plate 2. The insertion pin portion 54 is mounted to the mounting hole of the main plate 2 by being forced into it as indicated by the arrow F3. As a result, it is possible to press the inclined surface 52a of the second pin 52 against the second side 25b of the regulating portion 25. That is, it is possible to generate a pressing force F4 from the inclined surface 52a toward the regulating portion 25, making it possible to press the regulating portion 25 against the first pin 22 (See FIG. 3). As a result, it is possible to fix the regulating portion 25 in a state in which it is firmly held between the first pin 22 and the second pin 52.

Further, the inclined surface 52a is inclined so as to be gradually spaced away from the axis 53 as it extends from the main plate 2 in the first axial direction C1. Thus, it is possible to suppress detachment of the regulating portion 25 in the first axial direction C1 in a more satisfactory manner by the second pin 52.

### (Modification)

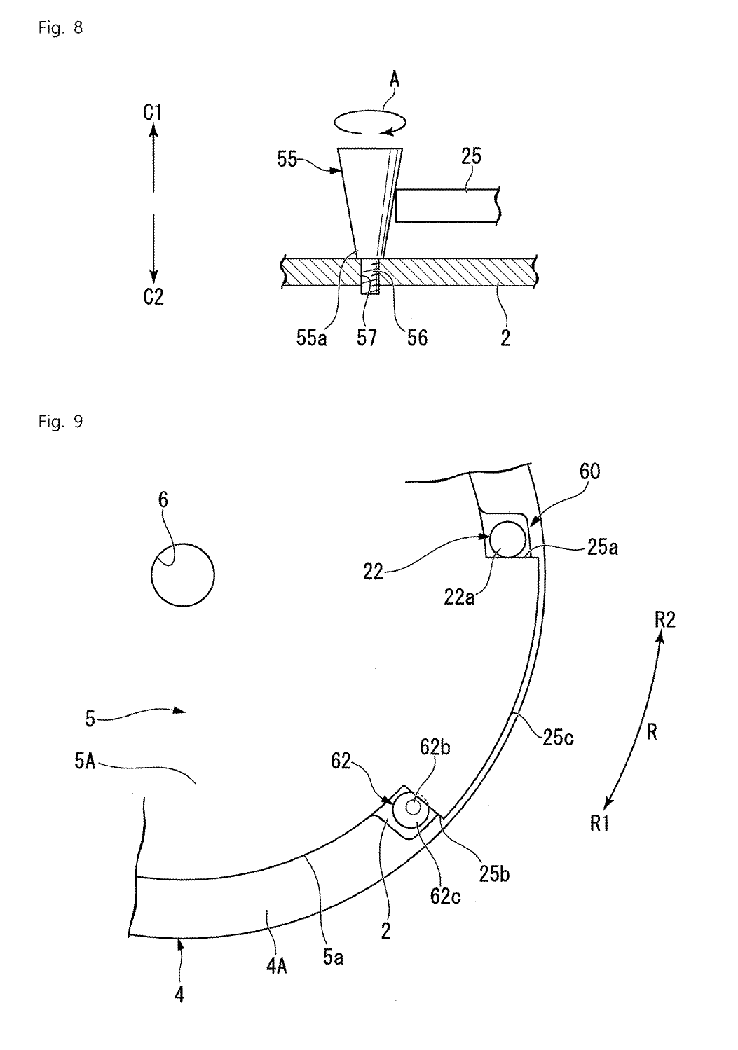

FIG. 8 is a sectional view of a second pin 55 according to a modification of the third embodiment.

While in the fixation structure 50 of the third embodiment the second pin 52 is mounted to the main plate 2 through forcing-in, this should not be construed restrictively. In another example, the second pin 55 can be detachably mounted to the main plate 2. For example, in the second pin 55, a screw portion 56 is coaxially formed at the end portion of a reduced-diameter portion 55a.

The screw portion 56 of the second pin 55 is arranged at a screw hole 57 of the main plate 2. By turning the second pin 55 in the direction of an arrow A, the screw portion 56 is threadedly connected to the screw hole 57. The second pin 55 is detachably mounted to the main plate 2.

Thus, it is possible to replace the second pin 55 in conformity with the regulating portion 25. That is, it is possible to prepare a large number of second pins 55 of different configurations, and to select a second pin 55 of an appropriate configuration in conformity with the regulating portion 25. As a result, when fixing the regulating portion 25 (that is, the display plate 5) in position, it is possible to perform fine adjustment of the interference by the second pin 55.

### Fourth Embodiment

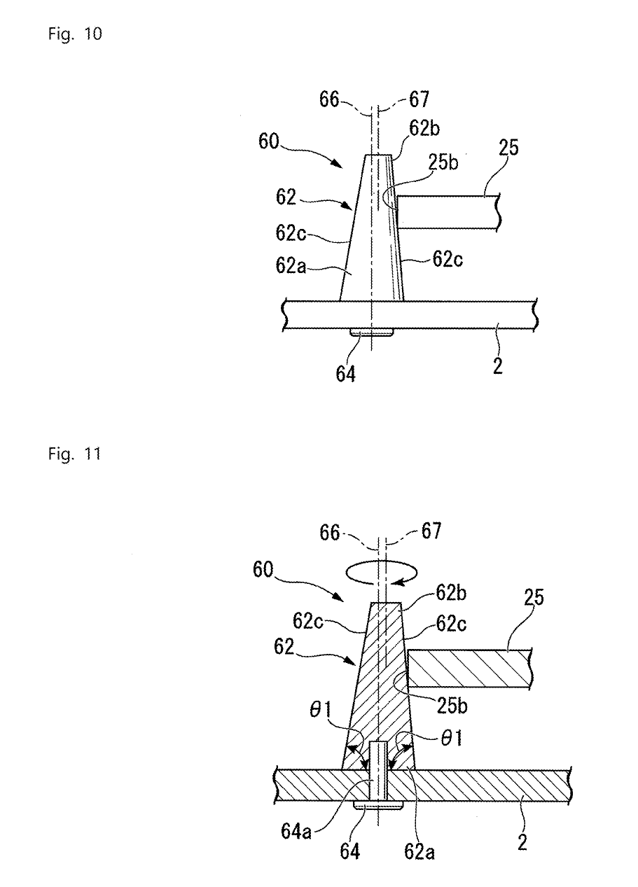

FIG. 9 is a plan view of the fixation structure 60 according to the fourth embodiment. FIG. 10 is a side view of a second pin 62 according to the fourth embodiment. FIG. 11 is a sectional view of the second pin 62 according to the fourth embodiment.

As shown in FIGS. 9 through 11, in the fixation structure 60, the second pin 23 of the first embodiment is replaced by the second pin 62. Otherwise, it is of the same construction as the fixation structure 20 of the first embodiment.

The fixation structure 60 is equipped with a support pin 64 mounted to the main plate 2, and the second pin 62 rotatably mounted to the support pin 64. The support pin 64 is mounted to the main plate 2, and a pin portion 64a protrudes on the second pin 62 side from the main plate 2. A proximal end portion 62a of the second pin 62 is rotatably mounted to the protruding pin portion 64a, and the proximal end portion 62a is in contact with the main plate 2.

The second pin 62 has the proximal end portion 62a formed in a circular configuration, and a distal end portion 62b formed in a circular configuration. A center axis 66 of the proximal end portion 62a is offset with respect to a center axis 67 of the distal end portion 62b. The center axis 66 of the proximal end portion 62a is rotatably supported by the pin portion 64a of the support pin 64.

The center axis 66 of the proximal end portion 62a and the center axis 67 of the distal end portion 62b are offset with respect to each other, whereby it is possible to change an inclination angle θ1 in the peripheral direction of the second pin 62. That is, by rotating the second pin 62 in the direction of the arrow around the pin portion 64a, it is possible to select the inclination angle θ1 of an inclined surface 62c of the second pin 62 in conformity with the regulating portion 25. As a result, when fixing the regulating portion 25 (that is, the display plate 5) in position, it is possible to perform fine adjustment of the interference by the inclined surface 62c.

The technical scope of the present invention is not restricted to that of the embodiments described above but allows various modifications without departing from the scope of the gist of the present invention.

For example, while in the above embodiments the first holding portion consists of the first pin 22 and the second holding portion consists of the second pin 23, this should not be construed restrictively. In another example, it is also possible for the first holding portion and the second holding portion to be formed by wall portions or the like.

Further, while in the above embodiments the fixation portion 21 is provided on the main plate 2 and the regulating portion 25 is formed on the display plate 5, this should not be construed restrictively. In another example, it is also possible to form the regulating portion in the main plate 2, and to provide the fixation portion on the display plate 5.

Further, while in the above embodiments the regulating portion 25, which is arranged between the second pin 23 side surface 22b of the outer peripheral surface 22a of the first pin 22 and the first pin 22 side surface 23b of the inclined surface 23a of the second pin 23, is held between the surfaces 22b and 23b on both sides, this should not be construed restrictively. In another example, it is also possible to hold the regulating portion between a surface 22c on the side opposite the second pin 23 of the outer peripheral surface 22a of the first pin 22 (See FIGS. 2 and 3) and a surface 23c on the side opposite the first pin 22 of the inclined surface 23a of the second pin 23 (See FIGS. 2 and 3).

That is, the regulating portion extends from the surface 22c to the surface 23c along the first main surface 5a of the display main body portion 5A of the display plate 5. It is also possible to hold this regulating portion between the surfaces 22c and 23c on both sides.

Further, while in the above embodiments the first member is the main plate 2 and the second member is the display plate 5, this should not be construed restrictively. In another example, it is also possible for the first member to be the case of a portable terminal or the like, and for the second member to be the display plate of a portable terminal or the like.

What is claimed is:

1. A portable apparatus component fixation structure comprising: a fixation portion provided on a first member, having a first holding portion and a second holding portion, and having an inclined surface on one of the first holding portion and the second holding portion; and
a regulating portion which is provided on a second member and which, while held between the first holding portion and the second holding portion, receives a pressing force from the inclined surface as it approaches the first member to be thereby locked to the fixation portion.

2. The portable apparatus component fixation structure according to claim 1, wherein the first holding portion is a first pin formed as a column; and
the second holding portion is a second pin formed as a truncated cone and having the above-mentioned inclined surface.

3. The portable apparatus component fixation structure according to claim 2, wherein the second pin is gradually reduced in diameter from the first member toward the second member.

4. The portable apparatus component fixation structure according to claim 2, wherein the second pin is gradually increased in diameter from the first member toward the second member.

5. The portable apparatus component fixation structure according to claim 2, wherein the second pin is rotatably mounted to the first member; and
a center axis of a proximal end portion on the first member side and a center axis of a distal end portion on the side opposite the first member are offset from each other.

6. The portable apparatus component fixation structure according to claim 2, wherein the second pin is detachably mounted to the first member.

7. The portable apparatus component fixation structure according to claim 1, wherein the regulating portion has an inclined side opposite the inclined surface and formed in an inclined configuration in conformity with the inclined surface.

8. The portable apparatus component fixation structure according to claim 1, wherein the first member is a main plate of a timepiece provided with the fixation portion; and
the second member is a display plate of the timepiece provided with the regulating portion.
